(19) United States
(12) Patent Application Publication
(10) Pub. No.: US 2026/0038477 A1
(43) Pub. Date: Feb. 5, 2026

(54) DENOISING METHOD, ELECTRONIC DEVICE AND STORAGE MEDIUM

(71) Applicant: AAC Acoustic Technologies (Shanghai) Co., Ltd., Shanghai (CN)

(72) Inventors: Bing Zhao, Shanghai (CN); Xuejing Sun, L.A., CA (US)

(21) Appl. No.: 19/002,623

(22) Filed: Dec. 26, 2024

Related U.S. Application Data
(63) Continuation of application No. PCT/CN2024/108997, filed on Jul. 31, 2024.

(51) Int. Cl. G10K 11/178

(52) U.S. Cl. CPC G10K 11/17883; G10K 11/17823; G10K 11/17881; G10K 2210/1282; G10K 2210/3028

(57) ABSTRACT

A denoising method, an electronic device and a storage medium are provided. The denoising method includes: determining an optimal compensation parameter from a preset compensation parameter set according to a current engine speed; and generating a cancellation signal according to the determined compensation parameter. The compensation parameter includes a parameter configured to compensate for at least one of following information: a reference signal, a filter coefficient, a speaker signal, or a microphone signal. The cancellation signal is configured to cancel current engine noise. At least it is beneficial for improving the denoising effect.

### CROSS-REFERENCE TO RELATED APPLICATIONS

This application is a continuation of International Application No. PCT/CN2024/108997, filed on Jul. 31, 2024, which is hereby incorporated by reference in its entirety.

### TECHNICAL FIELD

The present disclosure relate to the technical field of denoising, and in particular to a denoising method, an electronic device and a storage medium.

### BACKGROUND

With the technical development and competition in the automotive industry, the active denoising technology is increasingly appearing in various levels of automotive products, and the engine noise elimination technology is an important part among the various levels of automobile products. Whether it is traditional fuel vehicles or hybrid vehicles, active noise reduction can effectively reduce engine idle noise and certain acceleration noise in an environmentally friendly and low-carbon state, and is increasingly welcomed by more and more original equipment manufacturers and end customers. However, the denoising effect of current vehicles under high dynamics is not ideal.

### SUMMARY

Embodiments of the present disclosure provide a denoising method, an electronic device and a storage medium, which is at least beneficial to improving the denoising effect.

An aspect of the present disclosure provides a denoising method. The denoising method includes:

determining an optimal compensation parameter from a preset compensation parameter set according to a current engine speed, wherein the compensation parameter includes a parameter configured to compensate for at least one of following information: a reference signal, a filter coefficient, a speaker signal, or a microphone signal; and

generating a cancellation signal according to the determined compensation parameter, wherein the cancellation signal is configured to cancel current engine noise.

As an improvement, before the determining the optimal compensation parameter from the preset compensation parameter set according to the current engine speed, the method further includes:
acquiring engine speeds and microphone signals of a real vehicle in different working states, wherein the engine speeds are collected by a rotational speed sensor arranged at an engine, and the microphone signals are collected by a microphone arranged on the real vehicle; and
generating order slices corresponding to the reference signals of different orders according to the engine speeds and the microphone signals; and
determining the compensation parameter for compensating amplitudes of the reference signals corresponding to the reference signals of different orders according to order slices corresponding to the reference signals of different orders.

As an improvement, before the determining the optimal compensation parameter from the preset compensation parameter set according to the current engine speed, the method further includes:
acquiring an impulse response between each speaker and each microphone;
generating an amplitude response between each speaker and each microphone according to the impulse response between each speaker and each microphone; and
determining the compensation parameter for compensating amplitudes of each speaker signal corresponding to the reference signals of different orders according to the amplitude response between each speaker and each microphone.

As an improvement, the determining the compensation parameter for compensating amplitudes of each speaker signal according to the amplitude response between each speaker and each microphone, includes:
setting an amplitude response coefficient of amplitude responses between each speaker and each microphone outside a target frequency interval to 1, to obtain an effective amplitude response between each speaker and each microphone, wherein the target frequency interval is an working frequency range of an engine; and
determining the compensation parameter for compensating amplitudes of each speaker signal corresponding to the reference signals of different orders according to the effective amplitude response between each speaker and each microphone.

As an improvement, before the determining the optimal compensation parameter from the preset compensation parameter set according to the current engine speed, the method further includes:
acquiring microphone signals of a real vehicle in different working states;
determining order slices corresponding to the reference signals of different orders according to the microphone signals; and
performing simulation according to order slices corresponding to the reference signals of different orders, to obtain an optimal step size and an optimal leakage factor corresponding to the reference signals of different orders, wherein the optimal step size and the optimal leakage factor are the compensation parameter for compensating filter coefficients.

As an improvement, before determining the optimal compensation parameter from the preset compensation parameter set according to the current engine speed, the method further includes:
acquiring a denoising condition of a real vehicle, wherein the denoising condition includes at least one of following conditions: lowest denoising values of different seats or lowest denoising values in different working states; and
performing simulation according to the denoising condition to obtain the compensation parameter for compensating amplitudes of each microphone signal corresponding to the reference signals of different orders.

As an improvement, before the determining the optimal compensation parameter from the preset compensation parameter set according to the current engine speed, the method further includes:

performing simulation according to the compensation parameter currently acquired and a preset denoising target, to adjust the compensation parameter until a simulation stop condition is met, wherein the simulation stop condition includes: reaching the preset denoising target, or reaching preset times of adjustment.

As an improvement, the generating the cancellation signal according to the determined compensation parameter, includes:
compensating the reference signal and the microphone signal according to the compensation parameter;
generating a current filter coefficient according to the compensated reference signal, the compensated microphone signal, and an estimated secondary path;
compensating the generated filter coefficient according to the compensation parameter;
generating an initial cancellation signal according to the reference signal and the compensated filter coefficient; and
compensating the initial cancellation signal according to the compensation parameter, to obtain the cancellation signal.

Another aspect of the present disclosure provides an electronic device. The electronic device includes:
at least one processor; and
a memory communicatively connected to the at least one processor;
wherein the memory stores instructions executable by the at least one processor, and
the instructions are executed by the at least one processor to enable the at least one processor to perform the above denoising method in the embodiments of the present disclosure.

Still another aspect of the present disclosure provides a computer readable storage medium storing a computer program. The computer program, when executed by a processor, implements the above denoising method in the embodiments of the present disclosure.

The technical solutions provided by the embodiments of the present disclosure have at least following advantages.

By pre constructing a compensation parameter set for compensating at least one of a reference signal, a filter coefficient, a speaker signal, or a microphone signal, it is possible to more efficiently determine an optimal compensation parameter when generating a cancellation signal for the current engine speed, thereby obtaining at least a better reference signal, a better filter coefficient, a better speaker signal, or a better microphone signal. This ensures that the cancellation signal generated based on this will be closer to the actual cancellation signal required for engine noise, that is, a difference between an initially generated cancellation signal and an actually required cancellation signal is reduced. In this way, time for generating the actually required cancellation signal is shortened by adjusting subsequently, enabling faster and better noise reduction, and thus adapting to rapidly changing environment.

### BRIEF DESCRIPTION OF DRAWINGS

Many aspects of the exemplary embodiment can be better understood with reference to following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a denoising principle according to an embodiment of the present disclosure;

FIG. 2 is a schematic structural diagram of a denoising system according to an embodiment of the present disclosure;

FIG. 3 is a flowchart of a denoising method according to an embodiment of the present disclosure;

FIG. 4 is another flowchart of a denoising method according to an embodiment of the present disclosure;

FIG. 5 is another schematic structural diagram of a denoising system according to an embodiment of the present disclosure;

FIG. 6 is a flowchart of determining a compensation parameter involved in a denoising method according to an embodiment of the present disclosure;

FIG. 7 is a flowchart of determining a compensation parameter involved in a denoising method according to an embodiment of the present disclosure;

FIG. 8 is a flowchart of determining a compensation parameter involved in a denoising method according to an embodiment of the present disclosure;

FIG. 9 is a flowchart of determining a compensation parameter involved in a denoising method according to an embodiment of the present disclosure; and

FIG. 10 is a schematic structural diagram of an electronic device according to an embodiment of the present disclosure.

### DESCRIPTION OF EMBODIMENTS

It can be seen from the related art that the current vehicle denoising effect is not ideal, and it is urgent to provide a denoising method capable of improving the denoising effect.

It is found through analysis that the reason for the above problem is at least that the current engine noise cancellation mainly uses an adaptive algorithm to update a signal that generates reverse cancellation. In practical use, due to the existence of the secondary path, there is attenuation and reverberation in the automobile sound field, and the phase and the amplitude need to match the reference signal into a corresponding cancellation signal through an adaptive algorithm. However, in order to adapt to the optimal coefficient, it is necessary to stabilize for a period of time. In actual use, especially in the working condition of acceleration and deceleration, the dynamic range is relatively large, and the system is constantly in the change process and often cannot be adapted in time. An optimal step factor μ can be acquired under a steady state condition through a priori test. Different step factors μ are set in advance at different rotating speeds. However, the effect is still very limited when an in-vehicle environment is complex and rapidly changes. Meanwhile, in order to ensure robustness, teaching is more conservative, resulting in a slight discount on the actual denoising effect.

Based on this, the present disclosure provide a denoising method, an electronic device, and a storage medium. By pre-constructing a compensation parameter set for compensating at least one of a reference signal, a filter coefficient, a speaker signal, or a microphone signal, it is possible to more efficiently determine an optimal compensation parameter when generating a cancellation signal for the current engine speed, thereby obtaining at least a better reference signal, a better filter coefficient, a better speaker signal, or a better microphone signal. This ensures that the cancellation signal generated based on this will be closer to the actual cancellation signal required for engine noise, that is, a difference between an initially generated cancellation signal and an actually required cancellation signal is reduced. In this way, time for generating the actually required cancellation signal is shortened by adjusting subsequently, enabling faster and better noise reduction, and adapting to rapidly changing environment, and thus improving the denoising effect.

In order to make the objectives, technical solutions and advantages of the embodiments of the present disclosure clearer, various embodiments of the present disclosure will be described in detail below with reference to the drawings. However, those skilled in the art will appreciate that in various embodiments of the present disclosure, numerous technical details are set forth for the reader to better understand the present disclosure. However, even without these technical details and various changes and modifications based on following embodiments, the technical solutions claimed in the present disclosure can still be implemented.

Following embodiments are divided for ease of description, and should not constitute any limitation on specific embodiments of the present disclosure, and the embodiments can be mutually incorporated by reference without contradiction.

To facilitate those skilled in the art to better understand the denoising method provided in embodiments of the present disclosure, a principle of a denoising algorithm will be exemplified below.

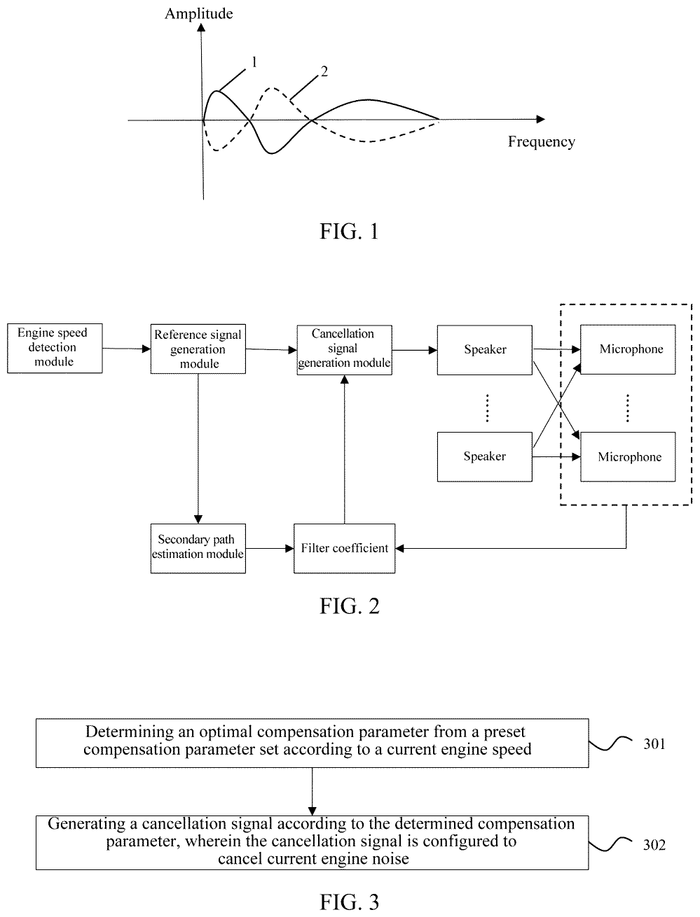

The core of the adaptive denoising algorithm is to generate a cancellation signal 1 as shown in FIG. 1. The cancellation signal 1 has the same amplitude and opposite phase as the actual engine noise 2. In this way, after the signal is superimposed, the engine noise 2 will be just cancelled, thereby realizing noise cancellation in the signal.

In order to generate an acoustic signal with the same amplitude and opposite phase as the noise, some embodiments of the present disclosure provide an architecture shown in FIG. 2 for calculation.

Firstly, as shown in FIG. 2, the reference signal generation module needs to first generate the reference signal based on the engine speed detected by the engine speed detection module. That is, the engine speed is tracked in real time, and a corresponding harmonic angular velocity signal is generated according to the detected engine speed, so as to obtain an angle signal by integrating the angular velocity, thereby acquiring a corresponding harmonic sine signal. In some examples, the reference signals can be determined by following expression:

$${x}_{m} ( t ) = {a}_{m} ( t ) * sin ( 2 π \cdot \frac{rpm ( t ) \cdot {O}_{m}}{60} \cdot t ) .$$

The rpm (t) is the engine speed signal detected in real time, Oₘ is the order value corresponding to the reference signal, and aₘ(t) is the amplitude corresponding to the reference signal.

It should be noted that the tracking of the engine speed can be further implemented by deploying a rotational speed sensor at the engine, so as to ensure the accuracy and reliability of the obtained engine speed through actual measurement. In some cases, the control signal of the engine can also be monitored and determined, which will not be elaborated here.

In this way, the reference signal constructed in the foregoing manner can have a frequency opposite to actually required engine noise. However, the same amplitude requirement has not been satisfied.

Based on this, the secondary path estimation module continues to estimate the secondary path. The secondary path refers to a path in which a signal output by a speaker on the vehicle is transmitted to the microphone. The reference signal is convolved through the estimated secondary path based on the filter coefficient updating module. The convolved signal and the corresponding error signal are multiplied and added to obtain an adaptive gradient. In some examples, the updating of the adaptive filtering coefficients is implemented by following expression:

$${w}_{mn} ( i + 1 ) = ( 1 - μ \cdot leaky ) \cdot {w}_{mn} ( i ) + 2 * μ \cdot {\sum }_{k = 1}^{K} {x}_{mnk}^{′} ( i ) \cdot {e}_{k} ( n ) .$$

The Wₘₙ(i+1) is a filter coefficient at a next moment, μ is a corresponding adaptive step factor, leaky is a leakage factor, eₖ(n) is a microphone signal collected by a corresponding error microphone, and Xₘₙₖ′(i) is a signal acquired after a reference signal is transmitted through the secondary path.

It should be noted that the error microphone can be any microphone arranged on the vehicle, and there can be one or more microphones. In some examples, a plurality of error microphones can be set up to obtain a more comprehensive and accurate microphone signal that reflects the signal.

In this way, by collecting the speaker signal through the microphone and providing feedback, the cancellation effect can be continuously tracked, which is beneficial for adjusting the filter coefficients to better adjust the cancellation signal and bring better denoising effect.

Further, the cancellation signal generation module acquires the cancellation signal based on the determined reference signals and the filter coefficients. That is, the reference signal and the coefficients updated by the adaptive filter are convolved to obtain the cancellation signal and transmit it through the speaker. The convolution process is as follows:

$${y}_{n} ( i ) = {\sum }_{m = 1}^{M} {\sum }_{l = 1}^{L} {w}_{mn , l}^{T} ( n ) \cdot {x}_{m} ( i - l + 1 ) .$$

The W_{mn.1}^{T} (n) is the adaptive filtering coefficient matched between the corresponding m-th reference signal and the n-th speaker, xₘ is the m-th reference signal, and yₙ is the cancellation signal output by the n-th speaker.

It should be noted that N speakers and K microphones are provided in order to achieve a better denoising effect. In some cases, one or more speakers or one or more microphones can also be provided according to requirements, which will not be repeated herein and subsequently.

From the above content, it can be seen that the generation and action of the cancellation signals will be influenced by the selection of the reference signals, iteration of the filter coefficients, and an internal structure of the speaker and the microphone. For example, when the amplitude of the reference signal differs significantly from the actual engine noise, the amplitude required to be adjusted by the filter will be larger, which will make the iteration of the filter coefficient more difficult. The initial value of the filter coefficient will affect the iteration of the filter coefficient. The speaker and the microphone affect the effect of cancelling the signal by affecting the filter coefficient.

Based on this, an embodiment of the present disclosure provides a denoising method, as shown in FIG. 3, including following steps.

Step 301: the optimal compensation parameter from the preset compensation parameter set is determined according to the current engine speed.

Step 302: a cancellation signal is generated according to the determined compensation parameter. The cancellation signal is configured to cancel current engine noise.

In this way, corresponding optimal compensation parameters are provided for different engine rotating speeds through a pre-constructed compensation parameter set, and optimization calculation of related parameters is completed in advance. In this way, after determining the current engine speed, the optimal compensation parameters can be directly determined, making subsequent adjustments smaller and enabling faster, more efficient, and accurate determination of the actual required cancellation signal without wasting too much time on parameter iteration and optimization. This can achieve noise reduction faster and better, adapt to rapidly changing environments, and thus improving the denoising effect.

To facilitate those skilled in the art to better understand embodiments shown in FIG. 3, it will be described as follows. It should be emphasized that following description should not limit embodiments shown in FIG. 3, and in other embodiments, the same effect can also be achieved in other manners.

For step 301, the compensation parameter includes a parameter used to compensate for at least one of following information: a reference signal, a filter coefficient, a speaker signal, or a microphone signal. It should be noted that the embodiments of this application do not limit the form of compensation parameters. For example, the compensation parameter used to compensate the filter coefficient can be directly the optimal filter coefficient, or can be other parameters that can affect the filter coefficients, such as the foregoing leakage factor, which will not be elaborated here.

In some examples, in the compensation parameter set, an optimal association relationship between compensation parameters corresponding to reference signals of different orders and orders has been constructed. Therefore, after obtaining the engine speed, the corresponding optimal compensation parameter can be matched through the order corresponding to the engine speed. In this way, an optimal compensation parameter is determined more efficiently, thereby improving the denoising efficiency.

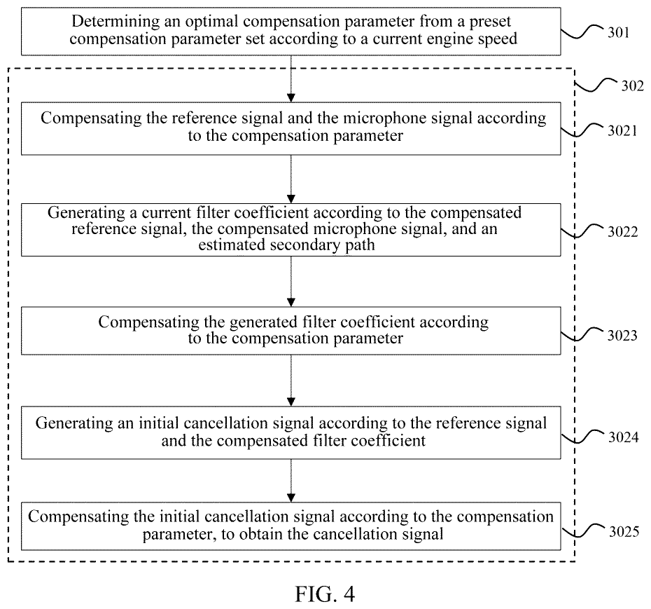

For step 302, in some embodiments, as shown in FIG. 4, it can be implemented by following steps.

Step 3021: the reference signal and the microphone signal are compensated according to the compensation parameter.

Step 3022: a current filter coefficient is generated according to the compensated reference signal, the compensated microphone signal, and an estimated secondary path.

Step 3023: the generated filter coefficient is compensated according to the compensation parameter.

Step 3024: an initial cancellation signal is generated according to the reference signal and the compensated filter coefficient.

Step 3025: the initial cancellation signal is compensated according to the compensation parameter, to obtain the cancellation signal.

Based on the denoising method provided in FIG. 4 and the structure of the denoising system shown in FIG. 5, it can be learned that when the denoising method provided in this embodiments of the present disclosure is applied to a vehicle, the compensation parameter set is first arranged to a compensation balancing subsystem. In this way, after an engine speed detection module detects a real-time engine speed, an initial reference signal is generated in a reference signal generation module. On the one hand, the signal is compensated for the reference signal by a corresponding compensation parameter provided by the compensation balancing subsystem, and after processing a secondary path estimated by a secondary path estimation module, the signal is sent to a filter coefficient update module, and a new filter coefficient is iterated together with a compensated microphone signal and a parameter provided by the compensation balancing subsystem. On the other hand, the signal is further sent to a cancellation signal generation module to act together with the updated filter coefficient to generate an initial cancellation signal. Finally, the initial cancellation signal is used as a final cancellation signal after being compensated for by the compensation parameter provided by the compensation balancing subsystem, and is sent to a speaker, to complete cancellation of engine noise. The compensation balancing subsystem further needs to obtain a real-time engine speed, to determine an optimal compensation parameter of a required output with an order corresponding to the real-time engine speed.

It is not difficult to find that embodiments shown in FIG. 5 is a system embodiment corresponding to the method embodiment, and the system embodiment can be implemented in cooperation with the method embodiment. The related technical details mentioned in the method embodiments are still effective in the system embodiments, and are not elaborated herein again to reduce repetition. Accordingly, related technical details mentioned in the system embodiments can also be applied to the method embodiments.

It should be noted that each module involved in the system embodiments is a logical module. In actual application, a logical unit can be a physical unit, or can be a part of the physical unit, or can be implemented by using a combination of multiple physical units. In addition, in order to highlight the innovative part of the present disclosure, the system embodiments do not introduce units that are less closely related to solving the technical problems proposed in the present disclosure, but this does not indicate that there are no other units in the system embodiments.

Meanwhile, in order to facilitate those skilled in the art to better understand how to determine the compensation parameters in the compensation parameter set, it will be described as follows. It should be emphasized that following description should not constitute a limitation on the compensation parameter set, and in other embodiments, the same effect can also be achieved in another manner, for example, the compensation parameter set is directly acquired through a simulation experiment.

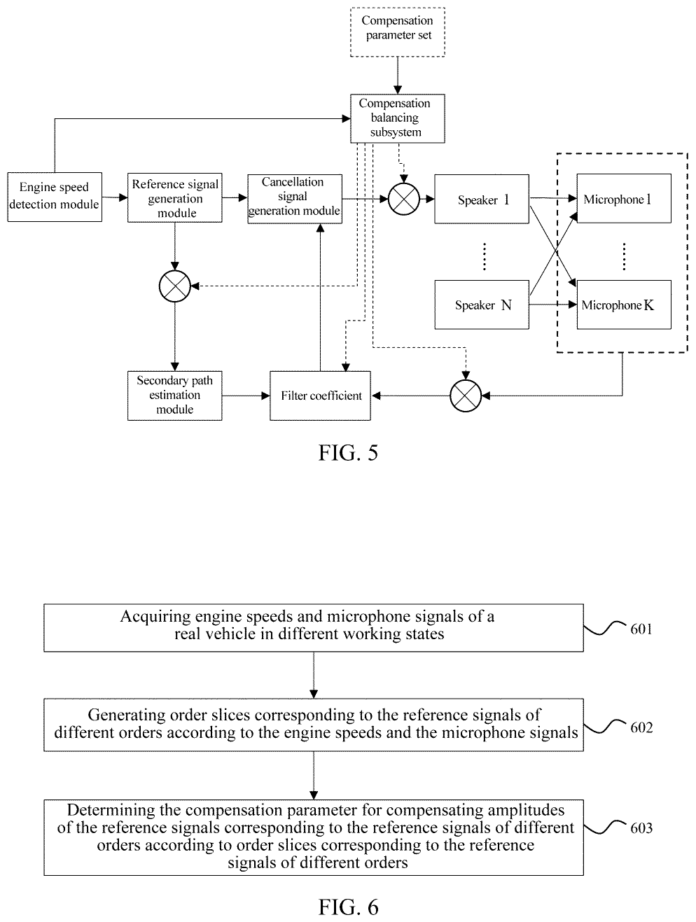

In some embodiments, as shown in FIG. 6, the compensation parameters for compensating the amplitudes of the reference signals can be determined by following steps.

Step 601: microphone signals of a real vehicle in different working states are acquired.

Step 602: order slices corresponding to the reference signals of different orders are generated according to the engine speed and the microphone signals.

Step 603: the compensation parameters for compensating amplitudes of the reference signals corresponding to the reference signals of different orders are determined according to order slices corresponding to the reference signals of different orders.

The engine speeds are collected by a rotational speed sensor arranged at an engine, and the microphone signals are signals collected by a microphone arranged on the real vehicle.

Assuming that the relationship between the compensation parameter for compensating the amplitude of the reference signal and the order signal of the reference signal is maintained in a table format, in some examples, firstly, a rotational speed sensor is arranged at an engine of the real vehicle, and microphones are arranged near the driver's left and right ears. Then the real vehicle collects acceleration information of different gears, engine speed information collected by the rotational speed sensor, microphone signals and the like. Order slices corresponding to the reference signal in the engine speed and the microphone signals are extracted. Then, the energy ratios in the order slices corresponding to the reference signals are normalized to obtain a preliminary three-dimensional reference signal balancing table: gear-order index-order frequency-reference signal gain value, which determines compensation parameters for compensating the amplitudes of the reference signals corresponding to the reference signals of different orders.

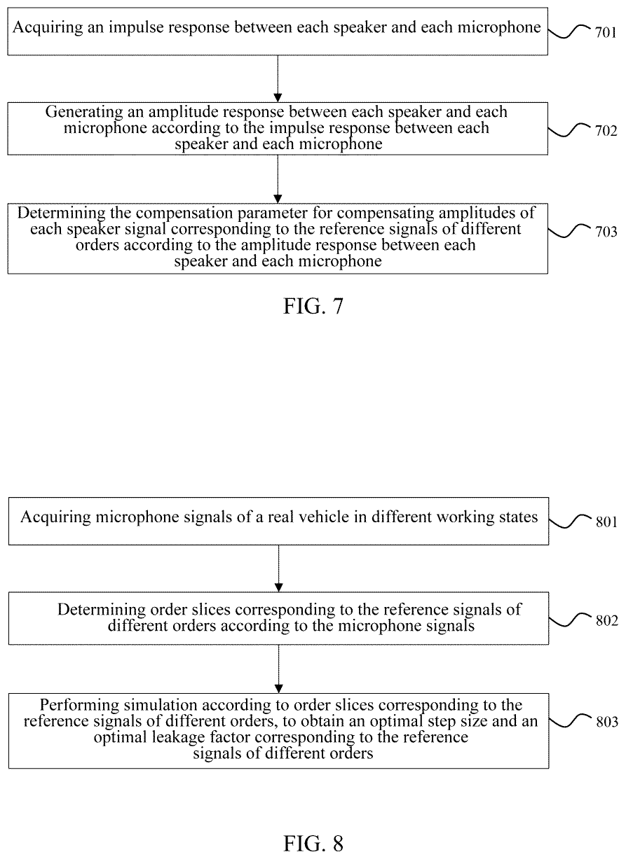

In some embodiments, as shown in FIG. 7, the compensation parameters for compensating the amplitudes of each speaker signal can be determined by following steps.

Step 701: an impulse response between each speaker and each microphone is acquired.

Step 702: an amplitude response between each speaker and each microphone is generated according to the impulse response between each speaker and each microphone.

Step 703: the compensation parameters for compensating amplitudes of each speaker signal corresponding to the reference signals of different orders are determined according to the amplitude response between each speaker and each microphone.

In some examples, determining the compensation parameters for compensating amplitudes of each speaker signal according to the amplitude response between each speaker and each microphone, can be implemented by: setting an amplitude response coefficient of amplitude responses between each speaker and each microphone outside a target frequency interval to 1, to obtain an effective amplitude response between each speaker and each microphone, wherein the target frequency interval is an working frequency range of an engine; and determining the compensation parameters for compensating amplitudes of each speaker signal corresponding to the reference signals of different orders according to the effective amplitude response between each speaker and each microphone. In this way, the influence of the non-engine working region can be eliminated, making the compensation parameters determined for compensating the amplitudes of each speaker signal more accurate. In some cases, the target frequency interval can be [20 Hz, 300 Hz].

Assuming that the relationship between the compensation parameter for compensating the amplitude of each speaker signal and the order signal of the reference signal is maintained in a table manner, in some examples, firstly, an actual impulse response between multiple sets of speakers and microphones is acquired by a frequency sweeping method or a white noise adaptive method, and then a corresponding amplitude response is acquired by the impulse response. Then, the amplitude response is transformed to a dB domain and normalize it to calculate the difference in the corresponding frequency response curve, which is the 0-amp (f) curve at each frequency point. Then, respective desired gains from speaker 1 to microphone 1, speaker 1 to microphone 2 . . . speaker 1 to microphone K are expected. Because a working range of engine noise cancellation is generally in a range of 20 Hz-300 Hz, a corresponding value in other frequency ranges can be set to 1, to obtain the compensation value of the speaker signal in the linear domain. For each speaker, in combination with all working conditions, orders, and speakers, an initial three-dimensional microphone compensation balancing table can be obtained: order index-order frequency-speaker index-speaker gain value table. That is, compensation parameters for compensating the amplitudes of each speaker signal are determined.

In some embodiments, as shown in FIG. 8, the compensation parameters for compensating the filter coefficient can be determined by following steps.

Step 801: microphone signals of a real vehicle in different working states are acquired.

Step 802: order slices corresponding to the reference signals of different orders are determined according to the microphone signals.

Step 803: simulation is performed according to order slices corresponding to the reference signals of different orders, to obtain optimal step sizes and optimal leakage factors corresponding to the reference signals of different orders. The optimal step sizes u and the optimal leakage factors leaky are the compensation parameter for compensating filter coefficients.

In some cases, the optimal step size u or the optimal leakage factor leak can be determined.

Assuming that the relationship between the compensation parameter for compensating the filter coefficient and the order signal of the reference signal is maintained in a table manner, in some examples, firstly, the real vehicle collects the engine speed and the denoising microphone signal under the acceleration working condition and the constant speed working condition. Then the values of the order slice of the real vehicle microphone under the corresponding frequency and rotation speed is extracted. Then, the simulation model program is applied offline for automatic iteration to obtain the optimal step factor. Then, the simulation model is applied under acceleration according to the corresponding adaptive step factor, and the leakage factor is adjusted, so that two two-dimensional tables can be acquired, which are step factors respectively: order index-order frequency-u gain value, leakage factor: order index-order frequency-leaky gain value table. Therefore, the compensation parameters for compensating the filter coefficients are determined.

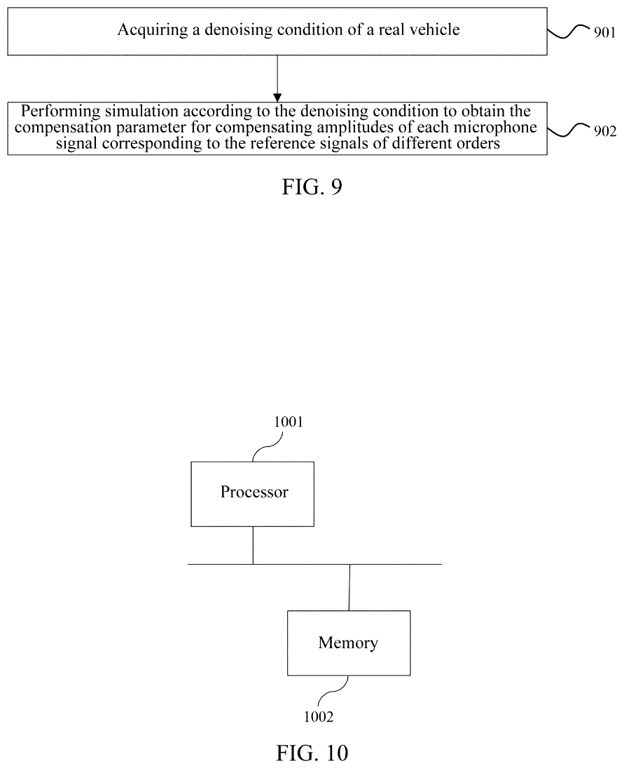

In some embodiments, as shown in FIG. 9, the compensation parameters for compensating the amplitudes of each microphone signal can be determined by following steps.

Step 901: a denoising condition of a real vehicle is acquired.

Step 902: simulation is performed according to the denoising condition to obtain compensation parameters for compensating amplitudes of each microphone signal corresponding to the reference signals of different orders.

The denoising condition includes at least one of following conditions: lowest denoising values of different seats and lowest denoising values in different working states.

Assuming that the relationship between the compensation parameter for compensating the amplitude of each microphone signal and the order signal of the reference signal is maintained in a table format, in some examples, firstly, the lowest denoising values for different seats of the vehicle are set, as well as the specific lowest denoising values for acceleration conditions, different speeds, and different operating conditions. Then, the denoising amounts between different microphones are balanced by loading a simulation program and a set target. For example, the microphone at position 1 shows that the current working condition has sufficient and redundant noise reduction, but the position denoising amount of the microphone 2 is insufficient. By calculating and automatically adjusting the weights of different microphones to balance the denoising amounts at different points, the corresponding three-dimensional microphone balancing table can be acquired: order index-order frequency-microphone index-microphone balancing factor value table. That is, compensation parameters for compensating the amplitudes of each microphone signal are determined.

It can also be understood that the above process is mainly from a real vehicle. Therefore, in order to further ensure the accuracy of the compensation parameter set, simulation experiments can be used to verify and adjust it. That is, in some embodiments, after determining the at least one set of compensation parameters through one or more of the foregoing embodiments or examples, the denoising method further performs simulation according to the compensation parameter currently acquired and a preset denoising target, to adjust the compensation parameter until a simulation stop condition is met. The simulation stop condition includes: reaching the denoising target, or reaching preset times of adjustment. In this way, the accuracy and reliability of the compensation parameter set acquired through two aspects of real vehicle testing and simulation experiments have been verified, thereby improving the denoising effect.

In some cases, the denoising target can be a specific target denoising value, position difference, stability, or the like. In particular, in some examples, after the simulation verification, a real vehicle test can be continued, so as to fine-tune the parameter to obtain the final version.

The steps of the above methods are divided only to describe clearly, and the implementation can be combined into one step or split into several steps, which are all within the protection of the present disclosure as long as the same logical relationship is included. Adding irrelevant modifications to the algorithm or process or introducing irrelevant designs, but not changing the core design of the algorithm and process is within the scope of protection of the present disclosure.

Another aspect of the present disclosure further provides an electronic device. As shown in FIG. 10, the electronic device includes: at least one processor 1001; and a memory 1002 communicatively connected to the at least one processor 1001. The memory 1002 stores instructions executable by the at least one processor 1001, and the instructions are executed by the at least one processor 1001 to enable the at least one processor 1001 to perform the denoising method described in any one of the foregoing method embodiments.

The memory 1002 and the processor 1001 are connected in a bus manner. The bus can include any quantity of interconnected buses and bridges, and connect one or more processors 1001 and various circuits of the memory 1002 together. The bus can also connect various other circuits such as peripherals, voltage regulators, and power management circuits, which are well known in the art. Therefore, it will not be further elaborated herein. The bus interface provides an interface between the bus and the transceiver. The transceiver can be one element, or can be multiple elements, such as multiple receivers and transmitters, providing units for communicating with various other apparatuses over a transmission medium. The data processed by the processor 1001 is transmitted over a wireless medium through an antenna, which further receives the data and transmits the data to the processor 1001.

The processor 1001 is responsible for managing the bus and general processing, and can further provide various functions, including timing, a peripheral interface, voltage regulation, power management, and other control functions. The memory 1002 can be used to store data used by the processor 1001 when performing operations.

Another aspect of the present disclosure further provides a computer-readable storage medium storing a computer program. When the computer program is executed by the processor, the foregoing method embodiments are implemented.

That is, all or part of steps in implementing the method in the above embodiments can be implemented by using a program to instruct related hardware. The program is stored in a storage medium, and includes several instructions used to enable a device (which can be a single-chip microcomputer, a chip, etc.) or a processor to perform all or part of the steps in the methods in the embodiments of the present disclosure. The above storage medium includes: various media that can store program codes, such as a USB flash drive, a mobile hard disk, a read-only memory (ROM), a random access memory (RAM), a magnetic disk, or an optical disk.

The above are merely exemplary embodiments of the present disclosure, which, as mentioned above, are not used to limit the present disclosure. Whatever within the principles of the present disclosure, including any modification, equivalent substitution, improvement, etc., shall fall into the protection scope of the present disclosure.

What is claimed is:

1. A denoising method, comprising:
determining an optimal compensation parameter from a preset compensation parameter set according to a current engine speed, wherein the compensation parameter comprises a parameter configured to compensate for at least one of following information: a reference signal, a filter coefficient, a speaker signal, or a microphone signal; and
generating a cancellation signal according to the determined compensation parameter, wherein the cancellation signal is configured to cancel current engine noise.

2. The denoising method as described in claim 1, wherein before the determining the optimal compensation parameter from the preset compensation parameter set according to the current engine speed, the method further comprises:
acquiring engine speeds and microphone signals of a real vehicle in different working states, wherein the engine speeds are collected by a rotational speed sensor arranged at an engine, and the microphone signals are collected by a microphone arranged on the real vehicle; and
generating order slices corresponding to the reference signals of different orders according to the engine speeds and the microphone signals; and
determining the compensation parameter for compensating amplitudes of the reference signals corresponding to the reference signals of different orders according to order slices corresponding to the reference signals of different orders.

3. The denoising method as described in claim 1, wherein before the determining the optimal compensation parameter from the preset compensation parameter set according to the current engine speed, the method further comprises:
acquiring an impulse response between each speaker and each microphone;
generating an amplitude response between each speaker and each microphone according to the impulse response between each speaker and each microphone; and
determining the compensation parameter for compensating amplitudes of each speaker signal corresponding to the reference signals of different orders according to the amplitude response between each speaker and each microphone.

4. The denoising method as described in claim 3, wherein the determining the compensation parameter for compensating amplitudes of each speaker signal according to the amplitude response between each speaker and each microphone, comprises:
setting an amplitude response coefficient of amplitude responses between each speaker and each microphone outside a target frequency interval to 1, to obtain an effective amplitude response between each speaker and each microphone, wherein the target frequency interval is an working frequency range of an engine; and
determining the compensation parameter for compensating amplitudes of each speaker signal corresponding to the reference signals of different orders according to the effective amplitude response between each speaker and each microphone.

5. The denoising method as described in claim 1, wherein before the determining the optimal compensation parameter from the preset compensation parameter set according to the current engine speed, the method further comprises:
acquiring microphone signals of a real vehicle in different working states;
determining order slices corresponding to the reference signals of different orders according to the microphone signals; and
performing simulation according to order slices corresponding to the reference signals of different orders, to obtain an optimal step size and an optimal leakage factor corresponding to the reference signals of different orders, wherein the optimal step size and the optimal leakage factor are the compensation parameter for compensating filter coefficients.

6. The denoising method as described in claim 1, wherein before determining the optimal compensation parameter from the preset compensation parameter set according to the current engine speed, the method further comprises:
acquiring a denoising condition of a real vehicle, wherein the denoising condition comprises at least one of following conditions: lowest denoising values of different seats or lowest denoising values in different working states; and
performing simulation according to the denoising condition to obtain the compensation parameter for compensating amplitudes of each microphone signal corresponding to the reference signals of different orders.

7. The denoising method according to claim 2, wherein before the determining the optimal compensation parameter from the preset compensation parameter set according to the current engine speed, the method further comprises:
performing simulation according to the compensation parameter currently acquired and a preset denoising target, to adjust the compensation parameter until a simulation stop condition is met, wherein the simulation stop condition comprises: reaching the preset denoising target, or reaching preset times of adjustment.

8. The denoising method as described in claim 1, wherein the generating the cancellation signal according to the determined compensation parameter, comprises:
compensating the reference signal and the microphone signal according to the compensation parameter;
generating a current filter coefficient according to the compensated reference signal, the compensated microphone signal, and an estimated secondary path;
compensating the generated filter coefficient according to the compensation parameter;
generating an initial cancellation signal according to the reference signal and the compensated filter coefficient; and
compensating the initial cancellation signal according to the compensation parameter, to obtain the cancellation signal.

9. An electronic device, comprising:
at least one processor; and
a memory communicatively connected to the at least one processor;
wherein the memory stores instructions executable by the at least one processor, and the instructions are executed by the at least one processor to enable the at least one processor to perform the denoising method as described in claim 1.

10. A computer readable storage medium storing a computer program, wherein the computer program, when executed by a processor, implements the denoising method as described in claim 1.
